(19) United States
(12) Patent Application Publication
(10) Pub. No.: US 2013/0253979 A1
(43) Pub. Date: Sep. 26, 2013

(54) OBJECTIVELY MANAGING RISK

(71) Applicant: PACIFIC GAS AND ELECTRIC COMPANY, San Francisco, CA (US)

(72) Inventors: Ramsey Williams, San Francisco, CA (US); James Sample, San Francisco, CA (US); Craig Rosen, Livermore, CA (US); Suneel Sundar, San Francisco, CA (US); Richard Jones, Spring, TX (US); Eddie Borrero, San Ramon, CA (US)

(73) Assignee: Pacific Gas and Electric Company, San Francisco, CA (US)

(21) Appl. No.: 13/801,254

(22) Filed: Mar. 13, 2013

Related U.S. Application Data
(60) Provisional application No. 61/610,248, filed on Mar. 13, 2012.

(51) Int. Cl. G06Q 10/06

(52) U.S. Cl. CPC G06Q 10/0635
USPC 705/7.28

(57) ABSTRACT

A computer implemented method for managing risk, which can include determining an organizational impact score from an aggregate of scenario impact scores and storing the organizational impact score in a memory of the computer. Some embodiments include calculating a likelihood score based upon an analysis of threats, imminence of each threat, and a likelihood associated with each threat, and storing the likelihood score in a memory of the computer. In some embodiments, an organizational maturity score is determined based on the ability of the organization to mitigate the actions of a potential threat and recover from a given scenario, and the organizational maturity score is stored in a memory of the computer. Some embodiments include calculating a Risk Index using a processor of the computer wherein the Risk Index equals the impact score multiplied by the likelihood score and divided by the maturity score.

### RELATED APPLICATIONS

This application claims priority under 35 U.S.C. §119 to U.S. Provisional Patent Application No. 61/610,248 filed on Mar. 13, 2012, the entire contents of which are incorporated herein by reference.

### BACKGROUND

Many organizations in today's business climate have developed methodologies for managing profit and loss through a study of internal practices and procedures in light of external forces. Those organizations regularly assess the organization at various levels to identify inefficiencies, unnecessary expenses, and potential liabilities. Documented methodologies for performing and describing such assessments are necessary to ensure that measures are objective rather than subjective and that processes are repeatable, such that meaningful data may be obtained and compared over time and/or through implementation of changes within the organization.

Information is increasingly vital to organizational management and its value as an asset increases accordingly. Managing information security, privacy, and compliance has become a critical domain for risk management efforts. However, traditional information assessment methodologies do not provide an accurate holistic measure of the health and safety of both a maturing organization and its customers. Such a holistic measure could permit an organization to more effectively apply its financial and human resources based on the maturity level of its organization.

### SUMMARY

Some embodiments of the invention provide a computer implemented method for managing risk. In some embodiments, an organizational impact score is determined from an aggregate of scenario impact scores. The organizational impact score can be stored in a memory of the computer. Some embodiments include calculating a likelihood score based upon an analysis of threats, imminence of each threat, and a likelihood associated with each threat, and storing the likelihood score in a memory of the computer. In some embodiments, an organizational maturity score is determined based on the ability of the organization to mitigate the actions of a potential threat and recover from a given scenario, and the organizational maturity score is stored in a memory of the computer. In some embodiments, a Risk Index is calculated using a processor of the computer wherein the Risk Index=(impact score)*(likelihood score)/(maturity score).

### DESCRIPTION OF THE DRAWINGS

FIG. 1 is a flow diagram showing the relationships among the variously described components according to some embodiments of the invention.

FIG. 2 is a flow diagram showing the appropriate application of controls to the assets and processes of an organization according to some embodiments of the invention.

FIG. 3 is a diagram showing the elements of a business capability 102 list according to some embodiments of the invention.

FIG. 4 is a diagram showing a break-out of components from a business capability 102 according to some embodiments of the invention.

FIG. 5 is a flow diagram showing the flow of information through the disclosed Organizational Control Framework 500 according to some embodiments of the invention.

FIG. 6 is a diagram showing how three forms of operational controls are manifested in the compliance and security posture of an organization according to some embodiments of the invention.

FIG. 7 is a table outlining a full list of Organizational Control Framework 500 controls according to some embodiments of the invention.

FIG. 8 is a flow diagram showing the effects of external forces on the components of the Organizational Control Framework 500 according to some embodiments of the invention.

FIG. 9 is a diagram outlining a grouping of control activities for a given component according to some embodiments of the invention.

FIG. 10 is a flow diagram showing a flow of action and information in the development of a Risk Index according to some embodiments of the invention.

FIG. 11 is a diagram showing a policy framework according to some embodiments of the invention.

FIG. 12 is a representation of control groups within three control families according to some embodiments of the invention.

FIG. 13 is a diagram showing the adoption of a Risk Index Methodology into the management of risk for an organization according to some embodiments of the invention.

FIG. 14 is a table outlining the contents of a risk profile according to some embodiments of the invention.

FIG. 15 is a graph showing an example of a Risk Index calculation range according to some embodiments of the invention.

FIG. 16 is a chart showing a calculation of scores having various risk scoring parameters according to some embodiments of the invention.

FIG. 17 is a table showing a ranking of consequences of varying natures according to some embodiments of the invention.

FIG. 18 is a set of tables showing the scoring of threats according to some embodiments of the invention.

FIG. 19 is a table showing the consideration of changes in actor capability and events relative to imminence according to some embodiments of the invention.

FIG. 20 is a table showing a targeting of groups of components relative to likelihood according to some embodiments of the invention.

FIG. 21 is a diagram showing typical information used in scenario development according to some embodiments of the invention.

FIG. 22 is a diagram showing a normalization of Risk Index scores into three tiers according to some embodiments of the invention.

FIG. 23 is a table outlining the use of information as a starting point in risk score range development according to some embodiments of the invention.

FIG. 24 is a table showing a maturity report reflecting an organization's ability and maturity to respond to any risk scenario according to some embodiments of the invention.

FIG. 25 is a table showing how various operations of the Risk Management Framework 100 can be broken out amongst various groups according to some embodiments of the invention.

FIG. 26 is a flow chart showing an illustrative methodology for measuring risk objectively according to some embodiments of the invention.

FIG. 27 is a chart showing the affects of continual investment in reducing risk according to some embodiments of the invention.

FIG. 28 is a chart showing a mitigation plan for changing a Risk Index according to some embodiments of the invention.

FIG. 29 is a diagram showing a computer system useful in some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

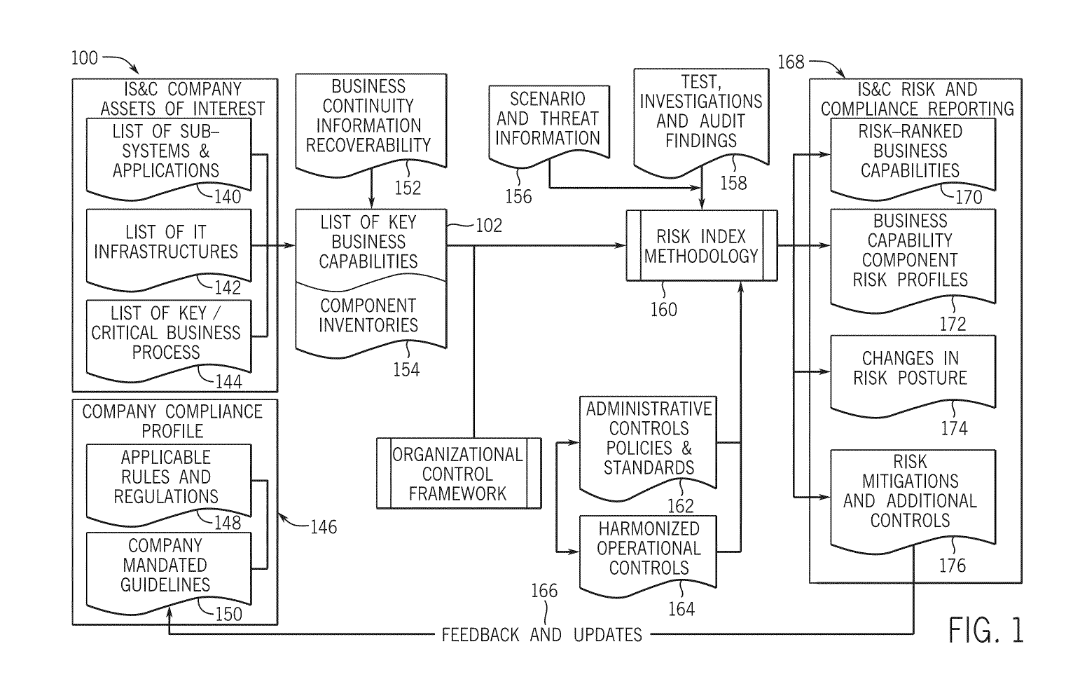

FIG. 1 is a flow diagram showing the relationships among the variously described components according to some embodiments of the invention. In this embodiment, the Risk Management Framework 100 comprises a methodology for managing features such as, for example, information security, privacy and compliance of organizational business processes, infrastructure, and information systems and technology. Such management features are provided through an implementation of a risk-based index to maintain and deploy appropriate controls and policies.

In some embodiments, the Risk Management Framework 100 comprises a set of core components including a list of key business capabilities 102. The key business capabilities 102 include an inventory of components corresponding to each capability. The list of key business capabilities 102 can document the organization's recoverability, control methods, implementation techniques, and risk profiles.

In some embodiments, the Risk Management Framework 100 also includes an Organizational Control Framework 500, that provides a body of harmonized controls that are deemed to meet or exceed selected rules, regulations and guidelines sourced, for example, by the vendor for the Unified Control Framework (UCF) and the organization. In some embodiments, a Risk Management Index 104 may provide a scoring system consistent with the requirements of a governmental agency, such as the Department of Energy (DOE) Utility Industry Guidelines. Practitioners will appreciate that a scoring system may be defined in light of the needs and requirements of the organization or any other entity to which the organization has accountability.

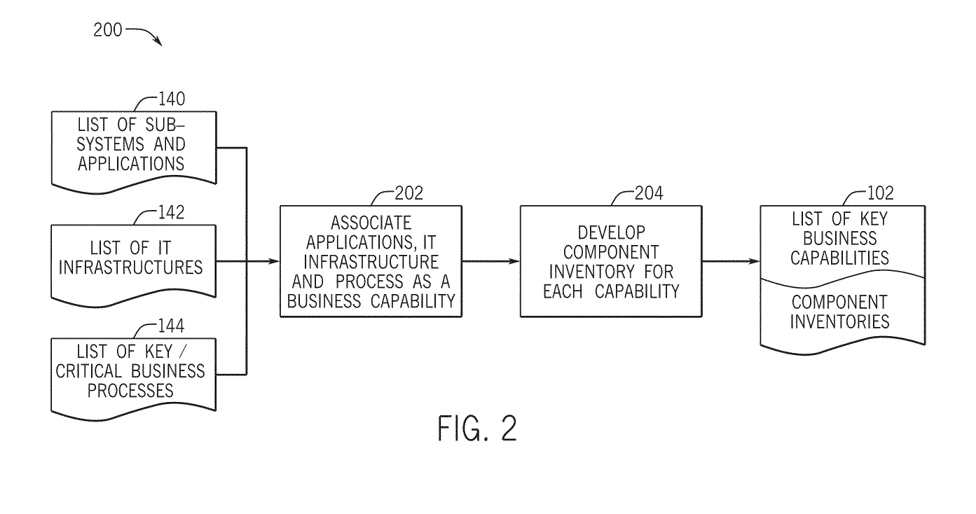

In some embodiments, the Risk Management Framework 100 further includes components that document a history of scenarios and threats, findings from audits, investigations and other tests, and disaster recover/business continuity information, such as recoverability. FIG. 2, described below, illustrates the relationship among the various Risk Management Framework 100 components.

FIG. 2 is a flow diagram showing the appropriate application of controls to the assets and processes of an organization according to some embodiments of the invention. One objective of some embodiments of the Risk Management Framework 100 is that the controls may be applied to the various assets and business processes rationally and objectivity. Due to a significant volume of potential cyber security and information security controls in common use, the organization, in some embodiments, can adopt a pragmatic and thorough method to determine which controls to use for a particular asset to maximize effectiveness, while limiting redundancy and over-application. As used herein, a business capability 102 is an association of processes, applications (i.e., sub-systems), and infrastructure elements that are indexed to one or more lines of business and represents the assets at risk. This association of assets may be referred to as the component inventory 154.

As used herein in accordance with some embodiments of the invention, the Organizational Control Framework 500 is a process and methodology deployed to manage and maintain the body of controls for all levels of assets at risk. In some embodiments, the Organizational Control Framework 500 core structure is a body of harmonized controls that contain both elements provided by UCF and those developed by the organization based on its compliance profile and business needs. In the Organizational Control Framework 500 of some embodiments, the term “authoritative sources” is used to denote the sources of the requirements of these controls. This is the same term that is used to describe sources that are added by the organization and are not supported by UCF. In some embodiments, these sources may include, for example, regulations, laws, guidelines and the organization's corporate policy statements.

In some embodiments, the Risk Management Index 104 is a calculation designed to provide a consistent approach for the assessment of information security risk to the organization's business processes, infrastructure, information systems, and technology. Furthermore, application of this calculation enables a consistent approach in prioritizing mitigations and corrective actions across various business units. In some embodiments, the Risk Management Index 104 is developed for each component of a given business capability 102. The analysis includes a development of a scenario 110 exercising one of more vulnerabilities of the component under consideration. In some embodiments, a basis of the calculation comprises a combination of three elements, including and impact score 112, a likelihood score 114, and a maturity score 116.

As used herein in accordance with some embodiments of the invention, impact 112 represents the consequence to the organization in light of a failure of one of more controls permitting an identified threat to bring harm to life, infrastructure, and brand. Likelihood 114 is based on a consideration of the magnitude, skills, ability, and recent activity of the particular threat and likely target. Maturity 116 is based on a consideration of the ability of the organization to mitigate the actions of a potential threat and recover from a given scenario 110.

In some embodiments, the maturity calculation for the Risk Management Index 104 may include the consideration of the state of a particular ability of an asset to mitigate an action. Therefore, all findings from investigations, audits, and other tests may be maintained and rationalized using designated Organizational Control Framework 500 structures.

As used herein in accordance with some embodiments of the invention, a scenario 110 is a real life example of how a particular vulnerability or control failure can lead to a potentially damaging situation for the organization. A scenario 110 can encapsulate the following elements: a discussion of what action is taking place and by whom, a discussion of how the assets vulnerability leads to a compromised situation, and a discussion of the impact and consequence to the organization.

Another element of Maturity 116 that is included in some embodiments of the Risk Management Framework 100 is the organization's ability to recover from a control failure or breach of any form. This information may be included in the calculation of the maturity of the organization and may be considered as important as the ability to prevent a control failure or breach. In some embodiments, corrective and detective controls may be considered with less weight to the overall maturity of the organization.

### Business Capability

In some embodiments, an important element of the disclosed Risk Management Framework 100 is the appropriate application of harmonized controls to the assets and processes that a compliance manager manages for compliance. The term “business capability” 102 is used herein to describe a particular combination of assets and processes.

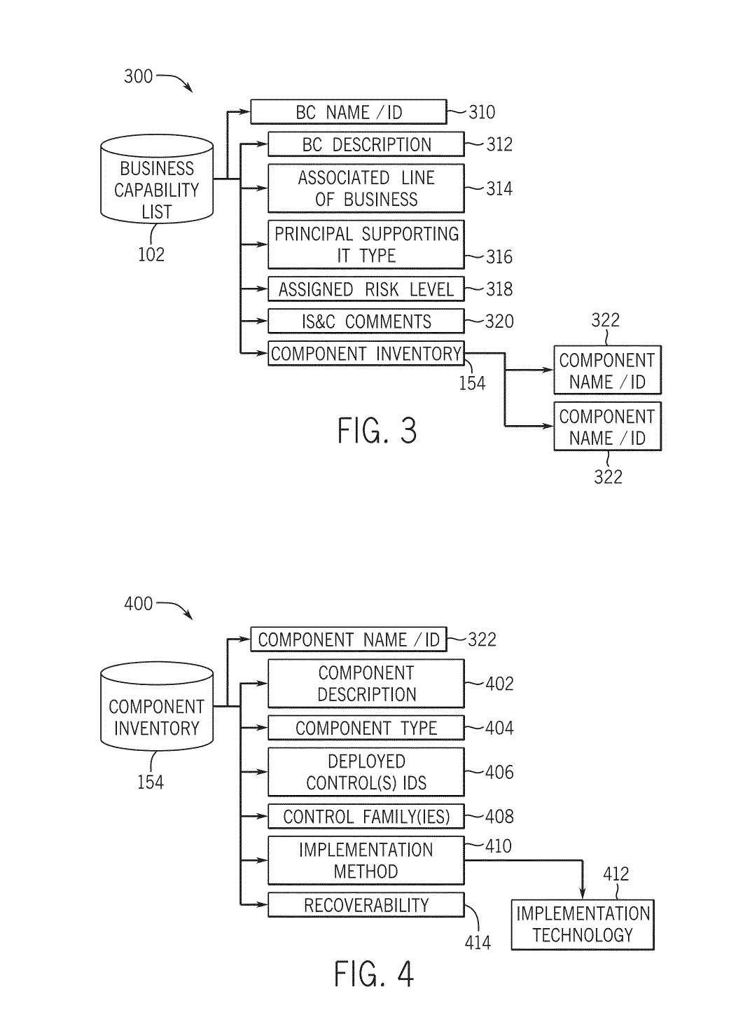

FIG. 3 is a diagram showing the elements of a business capability list according to some embodiments of the invention. Each business capability 102 should include sufficient information regarding its business processes, sub-systems, and other components to enable groups and/or individual controls to be variously assigned. In some embodiments, the business capabilities 102 are indexed to one or more lines of business.

In some embodiments, the concept of a business capability 102 forms a central means for relating organizational assets to the authoritative sources and their controls. In some embodiments, the management of this list of business capabilities may be considered a high-priority item, and tasked accordingly within the organization. Examples of typical business elements are described in reference to FIG. 4, which is a diagram showing a break-out of components from a business capability 102 according to some embodiments of the invention. Typical components that may be derived from the business capabilities 102 include, for example, the following:
Name/ID—Catalogue type identifier for the system
Description—Defined as ICS, General It, or Desktop
Lines of Business—e.g., Gas Operations, Electric Operations, Energy Supply, Generation, Customer Care, and Corporate Services
Supporting IT Type—Classification that business capability 102 is supported by an Industrial Control System, by General IT or by both forms of IT.
Assigned Risk Level—this may be maintained as High, Medium, or Low, as described below, with a normalized score from 1 to 5. The High, Medium, or Low mapping will then be used to determine the level of supplemental controls applied to a given system.
Organization Comments—general text field for free entry comments
Component Inventory—each component may be defined as a business process, sub-system, application only, or infrastructure only.

In some embodiments, each business capability 102 may then be broken out into individual components. Practitioners will appreciate that the following components and their respective attribute definitions have been included in this document for description only and do not limit the scope of the invention.
Component Name/ID—Catalogue type identifier for a component
Component Type—Type is a way of defining a component as a sub-system, application only, infrastructure only, or business process.
Deployed Control IDs—This may be a derived list of all the control IDs that are required for a component based on its characteristics and parent business capability 102.
Control Families—This may be one or more of the control families defined by UCF that provide the boundary structure for the body of controls. A control family may be considered as the area of information systems and infrastructure that are impacted by the controls within it.
Implementation Method and Technology—This piece of information should map to the organization classification of a control as Automatic, Manual, or Auto Manual. It should also include a reference field to allow the component to be mapped to particular control implementation artifacts, such as a password management system, 360 scan, or virus checker.
Recoverability—This is a percentage estimation of the ability of the component to be recovered should it be destroyed or compromised. This percentage may be determined using the organization's standard methods for evaluating the recoverability of a given system.

Based on the critical business processes identified by the organization, the following example list of key business capabilities may also be identified. The list may evolve as the components are identified and the effectiveness of the initial configuration is assessed.

Example business capabilities 102 may include, for example, Aviation Services and Management, Bulk Power Operations, Chemical Facility Operations, Distribution Operations, Generation (non-nuclear), Nuclear Facility Operations, Pipeline (Gas) Operations, Communications, Contract/Vendor Management, Customer Care, Enterprise-Wide Infrastructure Services, Financial Operations, Human Resources, Load Forecasting, Physical Facility Access Management and Control, Energy and Commodity Trading, and Work/Workforce Management.

### Organizational Control Framework 500

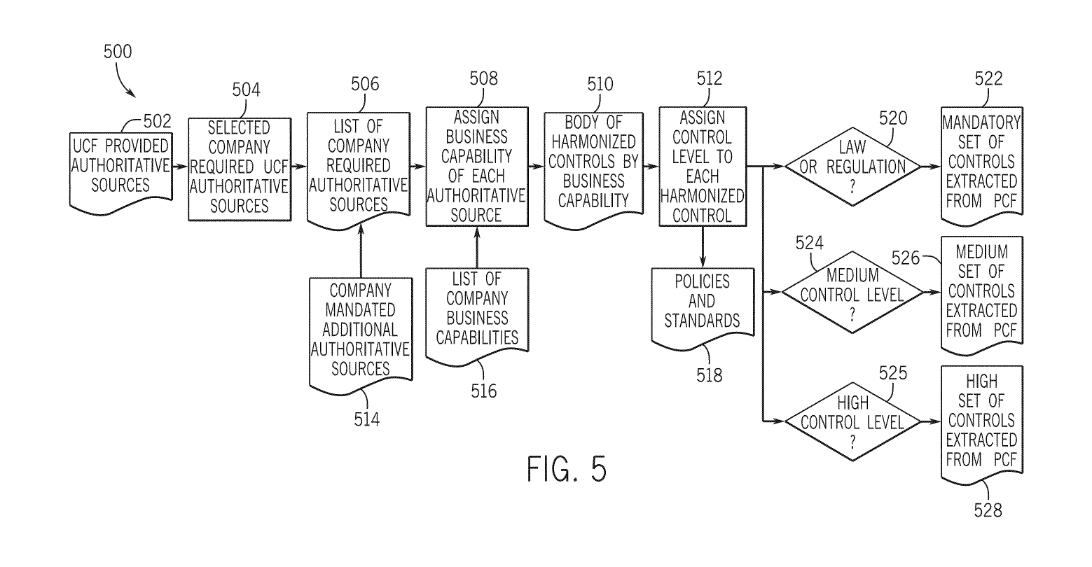

In some embodiments, an objective of the Organizational Control Framework 500 component of the Risk Management Framework 100 is the management and maintenance of the body of harmonized controls. These controls are derived to meet requirements arising from a combination of UCF and authoritative sources provided by the organization. FIG. 5 is a flow diagram showing the flow of information through the disclosed Organizational Control Framework 500 according to some embodiments of the invention.

In some embodiments, there are two forms of information sources for the Organizational Control Framework 500, including:

1) Authoritative sources provided by the UCF. The UCF may provide a body of harmonized controls based on any number of Authoritative Sources. These controls may be distributed in a database, xml, or Excel format, for example, depending on the form of a contract with UCF. In some embodiments, such controls may be updated by UCF on a defined interval (e.g., quarterly). The controls may be for information security, privacy, applicable physical security, etc.

2) Authoritative sources provided by the organization. This information may comprise a combination of regulations, rules, and other guidelines that the organization determines are needed for a complete organizational solution:
The organization updates the UCF sources and controls if they are required between UCF updates of the same regulations;
The organization non-covered UCF sources and controls for information security; privacy; and applicable physical security; and
The organization non-covered UCF sources and controls for IT owned infrastructure such as communication towers and infrastructure.

In some embodiments, the Organizational Control Framework 500 is configured to manage and maintain only the administrative sources and controls that are applicable to the organization. As such, the list of source information may be filtered in order to capture and retain only relevant data. For example, a primary filter may be defined as the asset class that Organizational Control Framework 500 defines as the business capability 102. A secondary filter is the “applicability” of the source based on whether it is a regulatory requirement or an organizational mandate.

In some embodiments, regulatory required authoritative sources may be manifested only at the Mandatory level of controls. The organization mandated authoritative sources may manifest themselves as Mandatory, Medium, or High level controls.

To accomplish this, each business capability 102 may be cross-referenced with the applicable administrative sources. This results in a body of harmonized controls that are variously relevant to the organization in regard to level of importance. For example, the harmonized controls may be classified as “Mandatory”, “Medium”, or “High”, each being described in greater detail below.

Mandatory—The primary source of Mandatory controls are those required by laws and regulations and are imposed on systems that may be subject to a set of regulations and laws deemed appropriate and necessary for the organization to meet their obligations under state and federal codes for those systems. The organization, at their discretion, may add documents to the authoritative source list that constitute corporate level policy and will have controls associated with them, which are deemed Mandatory by that policy document. These policy documents may require various levels of authorization, for example, by a corporate level officer in order to be considered Mandatory. In some embodiments, Mandatory controls may be applied to all components of all business capabilities, regardless of risk level, based on the regulatory requirements and policies covering those systems.

Medium—These controls may be considered as discretionary from a regulatory perspective and may apply to the components of those business capabilities that have a Medium or High risk ranking. The controls may have originated from authoritative sources, which are considered “advisory” or corporate policy deeming these controls as required for Medium and high-risk capabilities.

High—These are controls that may be considered as discretionary from a regulatory perspective and may apply to the components of those business capabilities that have a high-risk ranking The controls may have originated from authoritative sources that are considered “advisory” or corporate policy deeming these controls as required for high-risk capabilities.

The UCF provides structure to the controls through a concept known as the “impact area.” The origin of this concept is that each of the categories represents a typical IT Domain where these controls would typically be deployed. In some embodiments, UCF defines 14 of these impact areas. However, practitioners will appreciate that any number of impact areas may be defined without departing from the scope of the invention
Leadership and high-level objectives
Audits and risk management
Monitoring and measurement
Technical security
Physical and environmental protection
Systems continuity
Human resources management
Operational management
System hardening through configuration management
Records management
Systems design, build, and implementation
Acquisition of facilities, technology, and services
Privacy protection for information and data
Compliance and governance manual of style

Within the Risk Management Framework 100 and Organizational Control Framework 500, the impact areas may be referred to as “control families”, and they may take on additional meaning and relevance. In some embodiments, the control family may be used to provide clarity in status and the maturity of the organization in implementing the controls within the family, as well as in focusing effort and expenditure, and assigning responsibilities for action.

In some embodiments, a discretionary control is a supplemental control to those required by regulatory mandate that the organization has determined to be required in order to meet internal risk management objectives for High and Medium risk business capabilities. A discretionary control may be linked through Organizational Control Framework 500 to an authoritative source in a manner that is similar to a linking of a Mandatory control. Moreover, a discretionary control may be managed and maintained as part of the Organizational Control Framework 500 body of controls.

When considering which controls should be added beyond those deemed Mandatory, the consideration of the type of control should be a paramount question. Much analysis would demonstrate that preventive controls are favored, as they prohibit the threat from materializing. In this case, the cost and need of corrective action or recovery is minimized or zero. In addition, preventive controls may provide detailed reporting capability to facilitate an understanding of the changing capabilities and intents of the actors involved at the same time as preventing damage.

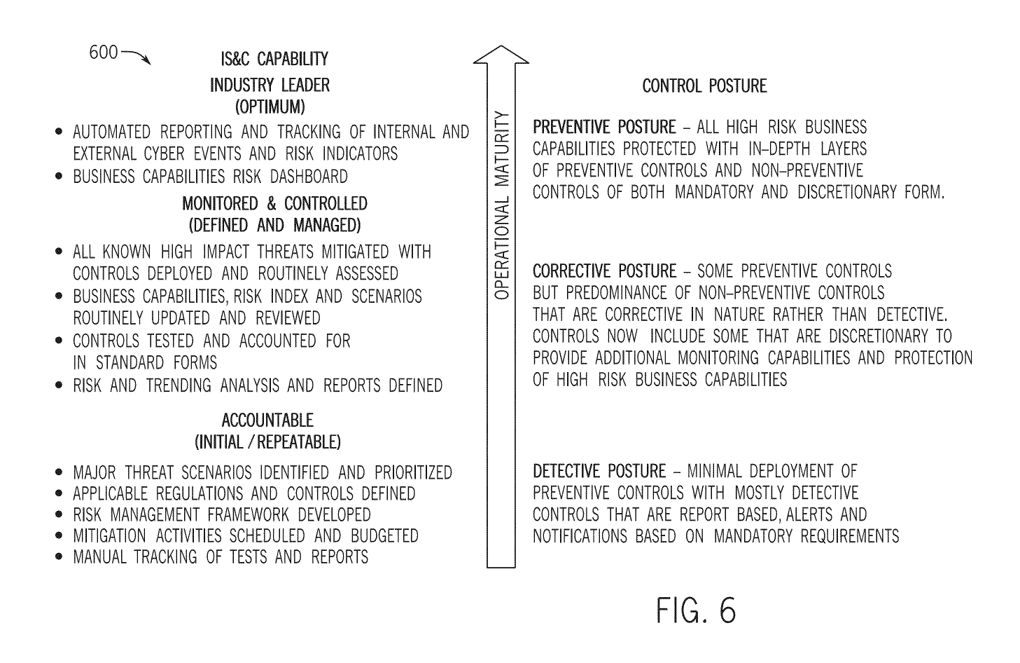

FIG. 6 is a diagram showing how three forms of operational controls are manifested in the compliance and security posture of an organization according to some embodiments of the invention. The diagram illustrates how the three forms of operational controls (preventive, corrective, and detective) manifest themselves in the compliance and security posture of the organization.

In some embodiments, an addition of any form of discretionary control may be accompanied by a “what-if” analysis. This may help determine whether an application of the control would improve the business capability 102, or one if its components' resilience to known threats through a reduction in the Risk Index. In some embodiments, discretionary controls may be restricted to fall in the Medium or High class of controls. Examples of areas where supplemental controls may reduce a risk level include:
Increase the number and capabilities of layers of controls or boundaries (defense in depth)
Exceed the nominally described frequency of monitoring and testing
Exceed the nominally described frequency of change/update
Increase the complexity of encryptions and password requirements

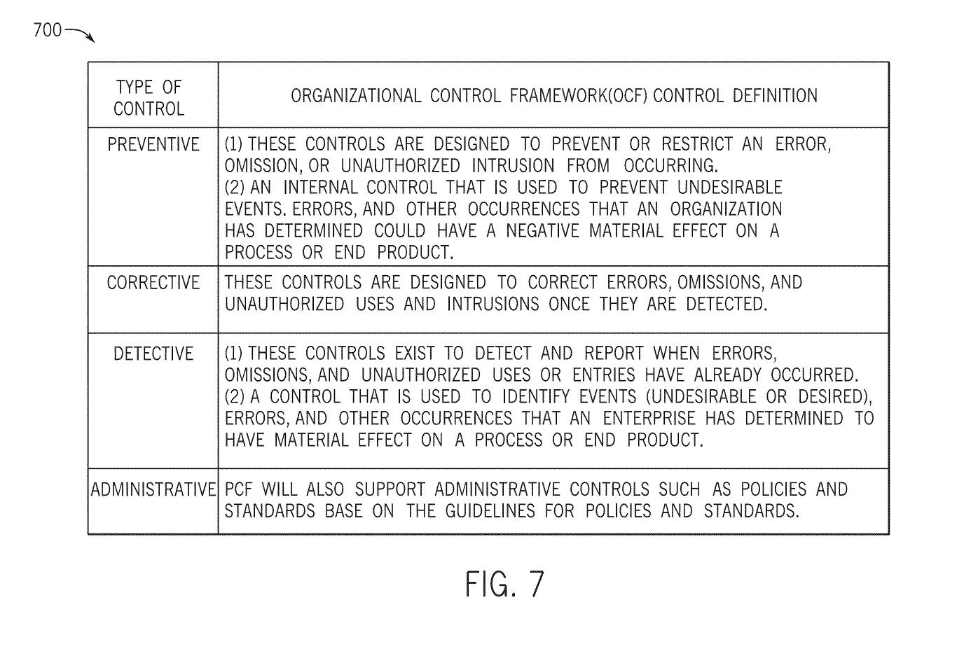

These controls may be added to the Organizational Control Framework 500 container under the organization's mandated authoritative document source label, for example, and maintained and updated with other organizational mandated documents and controls. Should the control be created by the organization, it may be provided a unique identifier and is referenced to an authoritative source that the organization may provide. If a source document does not exist and the control is required then an organizational policy document may be created and referenced as the authoritative source. Any organizational created controls may be developed and type defined using the same definitions as UCF provided for the operational controls of a type of preventive, corrective, or detective. FIG. 7 is a table outlining a full list of Organizational Control Framework 500 controls according to some embodiments of the invention.

In some embodiments, periodic maintenance of the source content of the Organizational Control Framework 500 engine may be desirable. Maintenance relating to the compliance requirements and the matching up of the updated UCF content with the organization's created content may also be performed at defined intervals, for example.

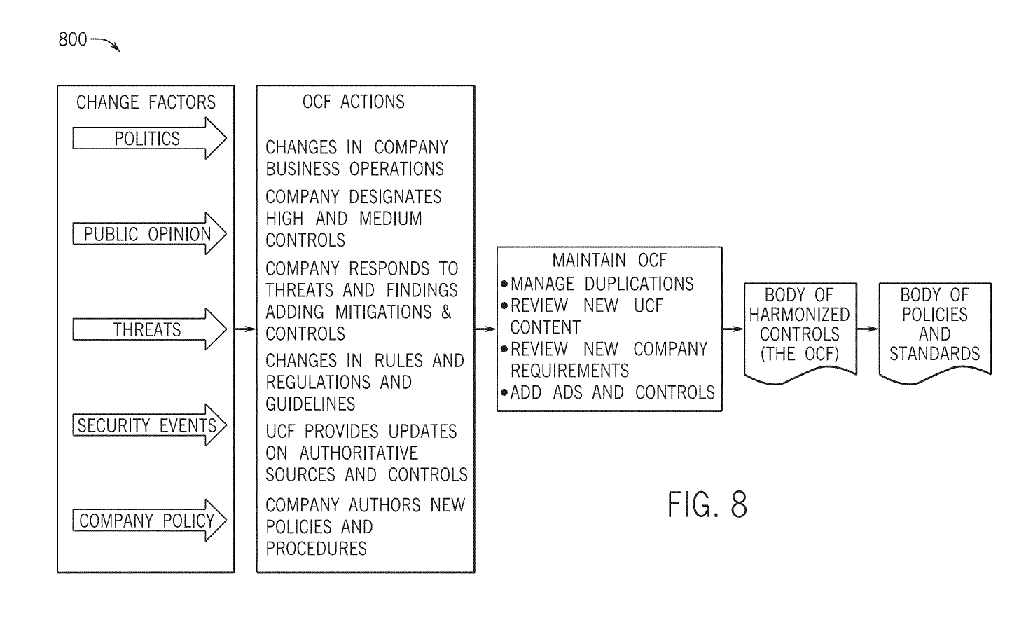

FIG. 8 is a flow diagram showing the effects of external forces on the components of the Organizational Control Framework 500 according to some embodiments of the invention. Specifically, this diagram illustrates how external forces may drive change to the components of Organizational Control Framework 500 and the resulting Policies and Standards.

As each Organizational Control Framework 500 Maintenance cycle is performed, a compliance review may be performed to ensure that the authoritative sources and their associated controls continue to provide the proper level of compliance coverage required to meet the organization's legal operating and reporting obligations.

### Control Deployment

As components of a business capability 102 are deployed, they may be associated with the relevant Organizational Control Framework 500 controls. In some embodiments, each component inherits the Risk Index of the business capability 102 that it is associated with and that share the same set of identified authoritative sources. As used herein, the Risk Index is a component of the Risk Index Methodology, as will be described in greater detail below. For each component deployed, determination may be made as to how these controls are to be satisfied and identify any implementation technology (i.e., artifact) that may be used to provide the controls.

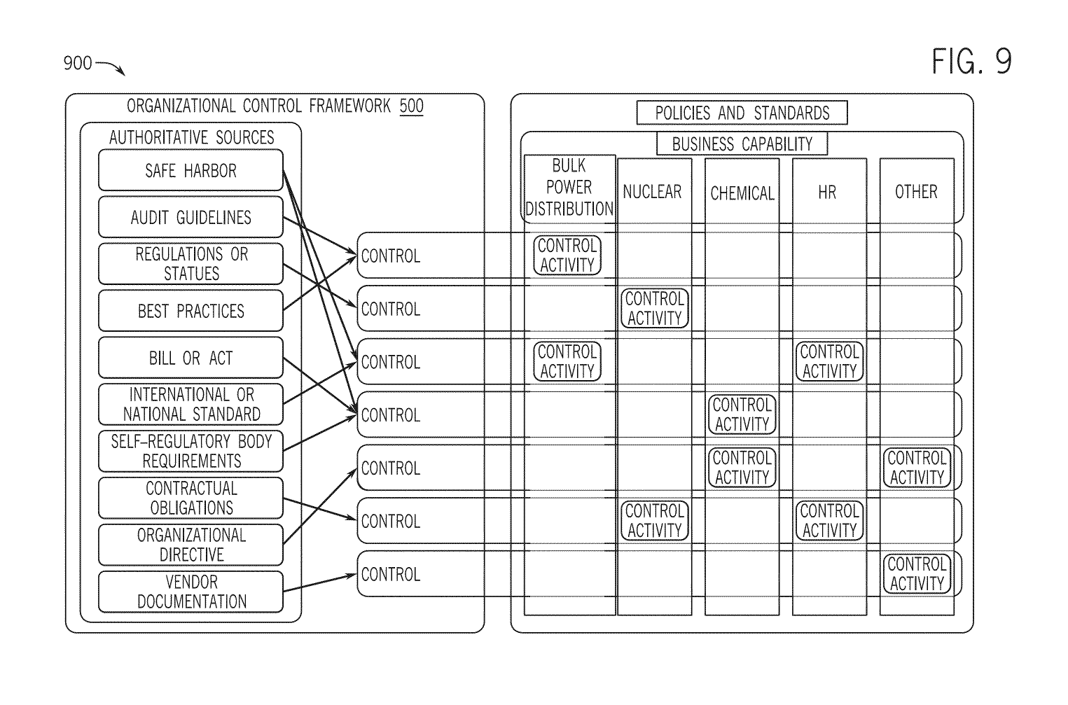

FIG. 9 is a diagram outlining a grouping of control activities for a given component according to some embodiments of the invention. In some embodiments, Organizational Control Framework 500 may define these activities as control activities. The grouping of these activities together for a given component may be considered the control baseline.

Examples of implementation technologies may include virus checkers, scans, password management tools, firewalls, etc. The control activity itself may be characterized using the organization's control type definition as automatic, manual, or auto/manual, and this attribute of a component labeled as the implementation method.

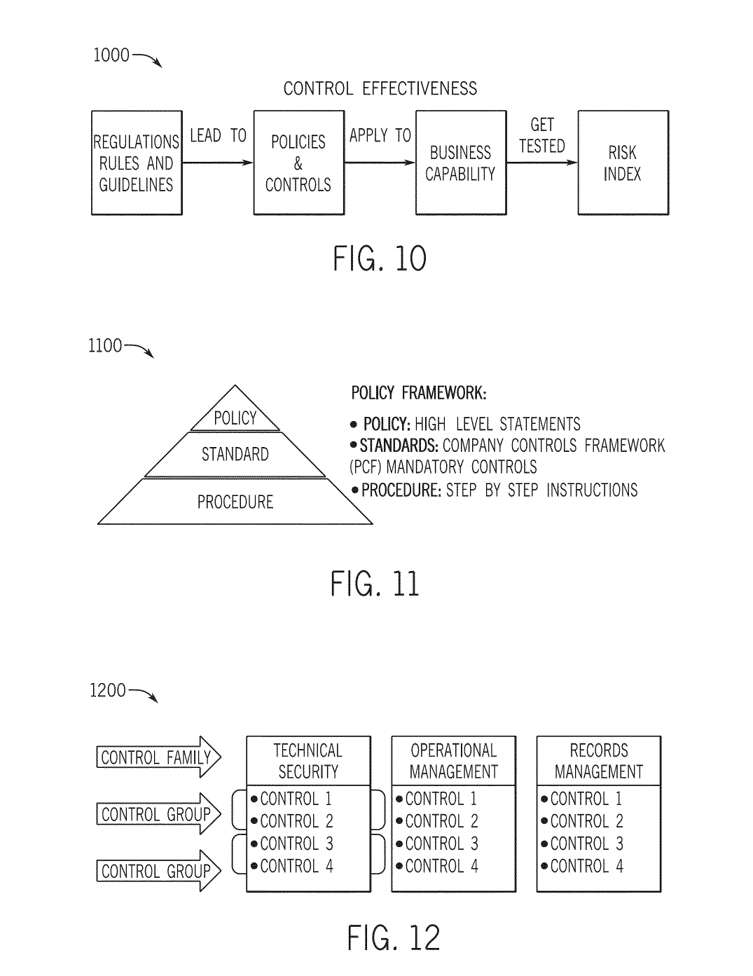

Ultimately the effectiveness of these controls and the control activities deployed are tested and the results may be compiled to develop an understanding of the level of maturity of the organization to meet the demands of the threats facing it. In some embodiments, a maturity score is also used in the development of the Risk Index. FIG. 10 is a flow diagram showing a flow of action and information in the development of a Risk Index according to some embodiments of the invention. This diagram illustrates this flow of action and information.

As each project is implemented, the control baseline for a project may be considered as the controls and their associated control activities that are required to be implemented for each sub-system or component being deployed. These requirements then form the basis against which any pre-production security testing can be executed.

### Policy, Standards and Procedures

FIG. 11 is a diagram showing a policy framework according to some embodiments of the invention. In some embodiments, the development of an organization's policies, standards, and procedures may be based on the controls outlined in the Organizational Control Framework 500, which is a set of harmonized controls based on organization's authoritative sources, and structured in accordance with the organization's defined initiatives.

FIG. 12 is a representation of control groups within the three control families according to some embodiments of the invention. The diagram provides a graphical representation of the control groups within three such families. In some embodiments, individual controls may be grouped together by topic to form control groups, which form the basis of standards and procedures using the Organizational Control Framework 500's control families.

In some embodiments, a policy outlines security roles and responsibilities, defines the scope of information to be protected, and provides a high-level description of the controls that are to be in place to protect the information. Moreover, the policy may make references to the standards that support it. Businesses may have a single encompassing policy, or several specific policies that target different areas. From a legal and compliance perspective, for example, an information security policy may be viewed as a commitment from senior managers to protect information. A documented policy is frequently a requirement to satisfy regulations or laws, such as those relating to privacy and finance. The security policy may be viewed as a business mandate and it may be driven from the top (i.e. senior management) downward in order to be effective.

In some embodiments, a security policy provides high-level, broad instruction about a significant business operation subject or function consistent with laws and regulations, the company's vision, values and goals, and any direction from a managing entity.

A standard consists of specific Organizational Control Framework 500 Mandatory controls that help enforce and support the information security policy of the organization. As used herein, a standard helps to ensure security consistency across the organization and often includes security controls relating to the implementation of specific technology, hardware, or software.

As used herein in accordance with some embodiments, a standard describes the major steps of a work process and/or major internal or external compliance requirements, and the roles and responsibilities of those involved. A standard may involve one or more organization, department, job function, or compliance requirement.

As used herein in accordance with some embodiments, a procedure consists of step-by-step instructions to assist in implementing the various policies and standards. While the policies and standards consist of the controls that should be in place, a procedure focuses on specifics, explaining how to implement these controls in a step-by-step fashion.

In some embodiments, a procedure comprises a detailed, step-by-step instruction that describes the functions, tasks, and expectations of employees who are responsible for performing a specific function or task. A procedure can include or refer to a set of safety, health, and environmental instructions that an employee needs in order to perform assigned tasks correctly.

In some embodiments, each type of document as previously described, has an inherent target audience within the organization. The grouping of these documents forms the concept of an information security policy framework. In some embodiments, this framework may include a unique indexing for each document according to the organization's standards. The documents may be maintained in a common repository and have an ability to be located by a control identifier, control family, document number, or a similar unique identifier. In some embodiments, the following steps may be implemented in order to develop policies, standards, and/or procedures. Practitioners will appreciate that the specific steps are presented for description only, and do not limit the scope of the invention.
1) Extract controls in their control families using the Risk Management Framework 100
2) Identify groups of controls within the control families using the Organizational Control Framework 500 hierarchy
3) Classify these groups and controls into policies, standards, and procedures using the GDI guidelines
4) Update/Draft documents
5) Obtain approval from appropriate organizational management
6) Update document catalogue
7) Publish documents

### Risk Index Methodology

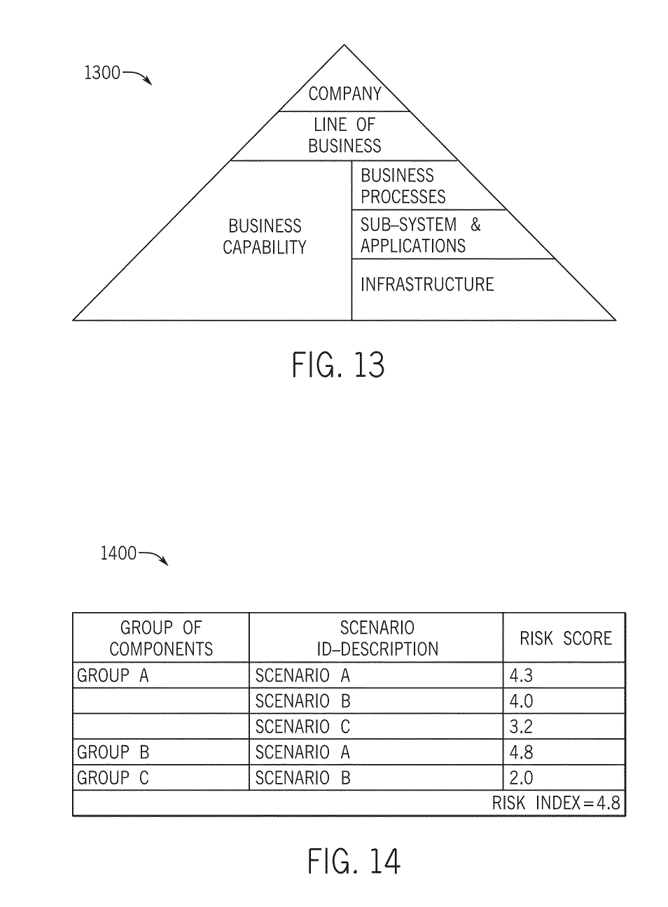

FIG. 13 is a diagram showing the adoption of the Risk Index Methodology into the management of risk for an organization according to some embodiments of the invention. The diagram explains how this concept is adopted into the management of risk at an organization using the Risk Management Framework 100 applied across various lines of business. An objective of the Risk Index Methodology in some embodiments is to provide a consistent approach for the assessment of information security and related risks to the organization's business processes, infrastructure, information systems, and technology. The methodology may provide a consistent approach for prioritizing mitigations and corrective actions that are identified as necessary to remediate the risk associated with components within a given system.

The DOE has published a set of guidelines known as the “Electricity Sector Cybersecurity Risk Management Process Guideline,” dated September 2011. The DOE guidelines define “risk” as a function of threats, vulnerabilities, impacts, and likelihood. According to the DOE, these risks should then be managed according to three tiers, Organization, Business Process, and Information Technology/Industrial Control Systems.

Under the DOE guidelines, each business capability 102, and/or one of its components, would then have a classification to indicate whether it should be considered as an industrial control system or general IT and desktop. This information may also be considered when framing the risk of a particular component or its business capability 102.

In some embodiments, the framing of the risk and the development of the Risk Index associated with a given system, is accomplished by considering the risks associated with system components. Each system component may be vulnerable or exposed to a variety of potentially damaging scenarios. As such, each of these scenarios 110 may be evaluated for groups of components, a score being computed for each scenario 110. A group of components may consist of a single component depending on the action of the scenario 110. FIG. 14 is a table outlining the contents of a risk profile according to some embodiments of the invention. The table further illustrates how the Risk Index for a given business capability 102 results as the maximum risk score for a given scenario 110 within any component.

Over time, as each new set of risk/threat scenarios, vulnerabilities findings, state of controls, and impact/likelihood changes, the risk profile may be updated using the new risk score associated with that scenario 110.

The Risk Management Framework 100 is compliant with the tenants of the DOE guidelines and calculates a Risk Index 104 as the maximum risk score for a business capabilities components where:

Risk Index 104=Impact*Likelihood/(Control)Maturity for a given scenario 110.

It is important to note that the use of control maturity in a risk formula results in a risk score for residual risk. As such, the Risk Index 104 is a measure of residual risk. It mitigates the native risk, which is provided by the framing of the risk with impact and likelihood, by using a measure of the maturity of the controls and recoverability of a given component. The exposing of such a measure permits an organization to more effectively apply its financial and human resources based on the maturity level of its organization.

Those of ordinary skill in the art will appreciate that the precise calculation used in determining a risk score may vary without departing from the scope of the invention. It should be further appreciated that there are likely multiple methods, in addition to what is disclosed herein, for calculating a set of variables to derive a meaningful outcome without deviating from the methodologies described herein. The Risk Management Framework 100 may employ calculations having greater or fewer variables, constants, weighting values, and the like, which are used to create a desired outcome in accordance with the methodologies disclosed herein. For example, a more complex calculation that may be implemented within the Risk Management Framework 100 in accordance with some embodiments is as follows:

$$\begin{matrix}Risk = Impact \times Likelihood \times Maturity \\ = ( threat \times Imminence ) \times Damage \times Mitigation \times Maturity \\ = [ \begin{matrix}\begin{matrix}\begin{matrix}τ ( actors + capacity + intention ) \times immence \times \\ δ [ safety \times 1 ( \begin{matrix}loss of life + da m age to \\ organizational infrastrusture\end{matrix} ) +\end{matrix} \\ financial \times ( \begin{matrix}damage to organizational infrastructure + \\ damage to business operations\end{matrix} ) +\end{matrix} \\ reputational \times damage to brand\end{matrix} ] \times \\ Mitigation \times Maturity\end{matrix}$$

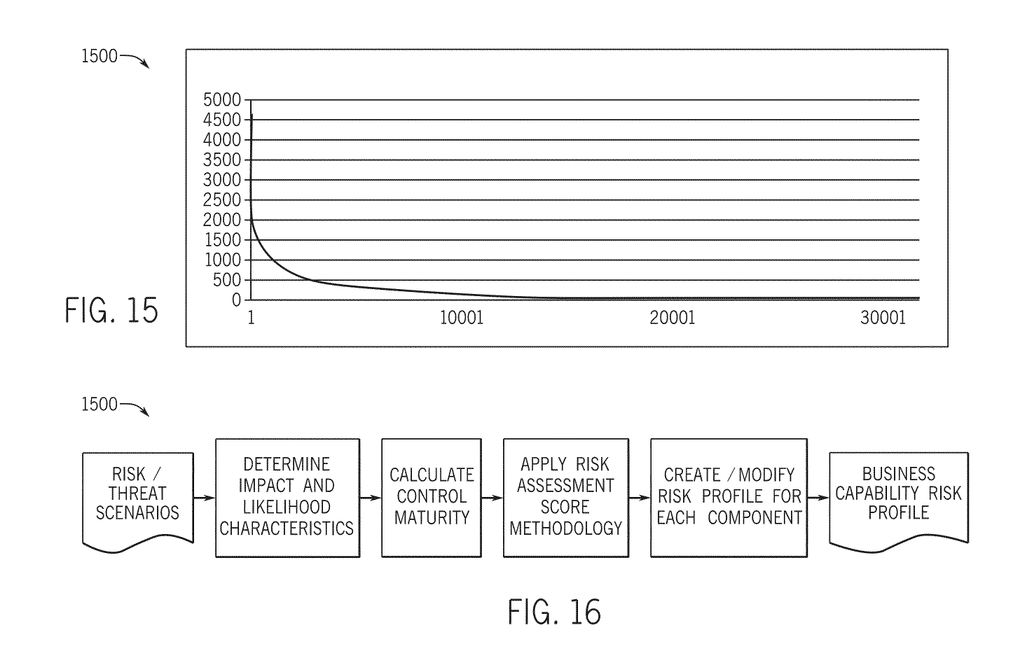

FIG. 15 is a graph showing an example of a Risk Index 104 calculation range according to some embodiments of the invention. The behavior of the scores is shown in the graph with a range of a risk score being from 0 to 4680 under the use of the various scoring parameters discussed below.

FIG. 16 is a chart showing a calculation of scores having various risk scoring parameters according to some embodiments of the invention. Impact (sometimes called “Consequence”) is ranked from Low to very High based on the nature of the resulting damage/harm to life, facilities, critical infrastructure and brand using a scoring table.

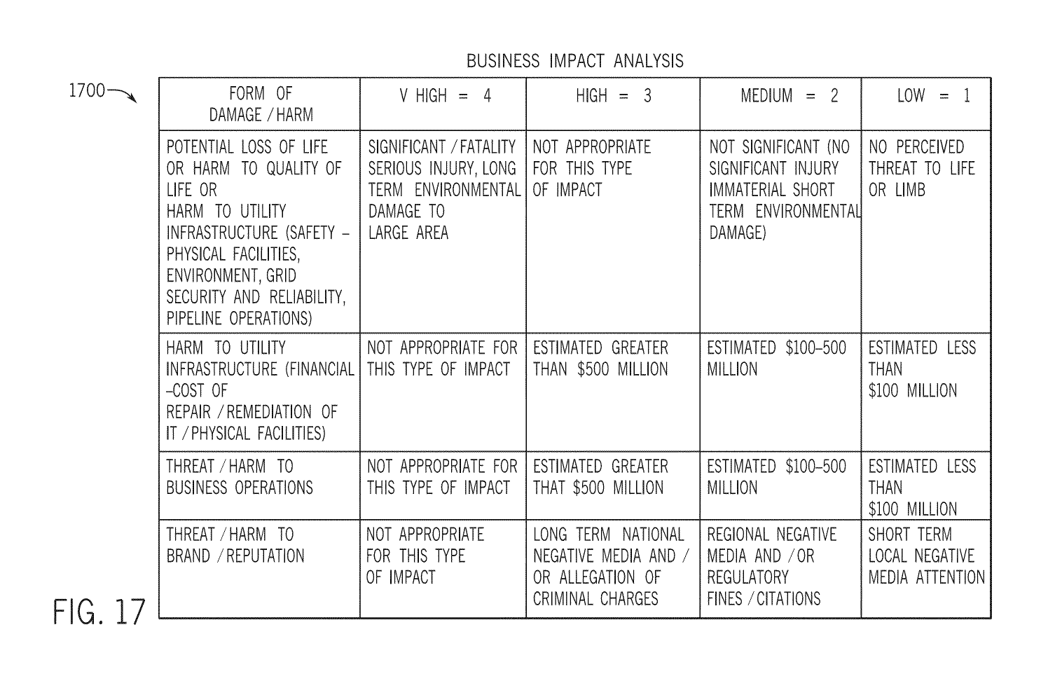

FIG. 17 is a table showing a ranking of consequences of varying natures according to some embodiments of the invention. In some embodiments, the values for damage/harm follow the organization's corporate standards. For example, the scoring system may follow guidelines provided by a threat management team, with an overall impact score being the sum of the score for each row for each scenario 110 for a group of components. Damage/harm to business operations may consider, but not be limited to, factors such as:
Impact to vital records—rights of way documents, contracts etc
Information release—Personal identified information and proprietary data
Impact to DR capability
Impact to staff retention and recruiting
Damage to information integrity
Stress/impact on consumer services
Loss of income and opportunity
Contract liability
Cost of mitigation and penalties
Increase in regulatory oversight
Third Party damage/harm and liabilities

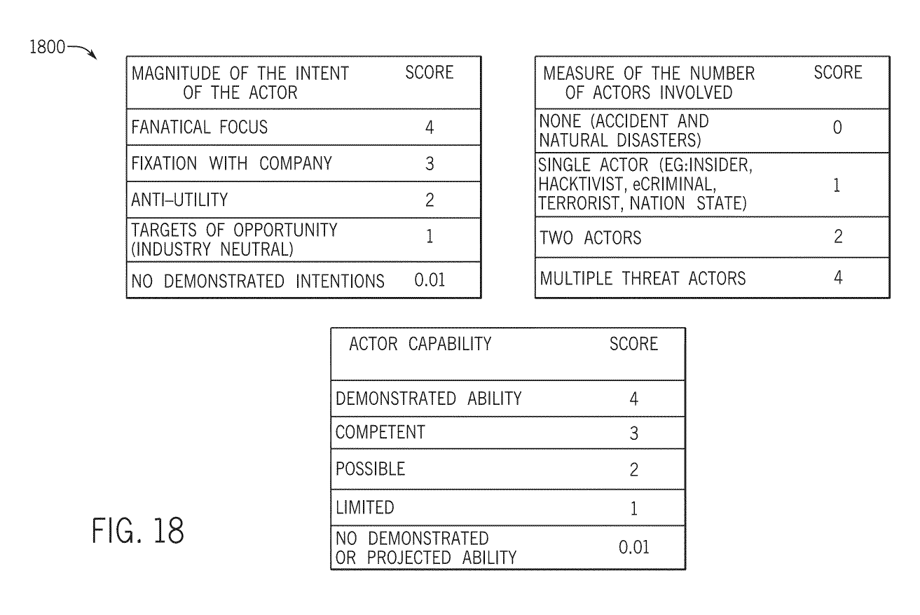

As used herein, likelihood is a product of three factors: 1) threats; 2) imminence of threat; and 3) the targeting likelihood of the component under consideration. In some embodiments, its range of values is from 0.002 to 360. Threats may be scored as a sum of the measure reflecting the number of types of adversaries, and the highest level of capability and intent of adversaries, with a value from 0.02 to 12. FIG. 18 is a set of tables showing the scoring of threats according to some embodiments of the invention.

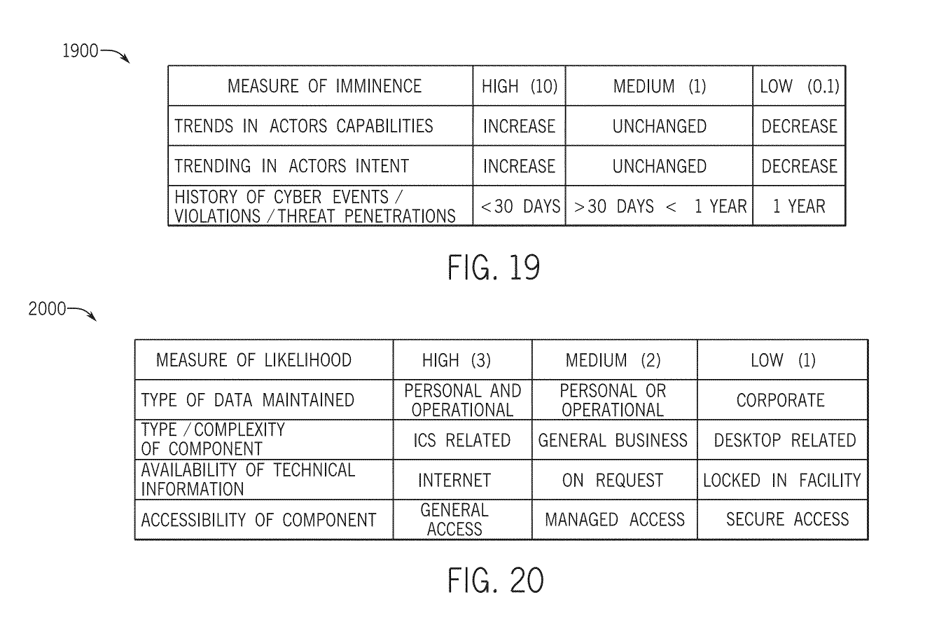

FIG. 19 is a table showing the consideration of changes in actor capability and events relative to imminence according to some embodiments of the invention. In some embodiments, imminence considers the changes in actor capability and recent events and ranges from 0.1 to 10 based on the average of the scores in the categories shown in FIG. 19.

The scoring of imminence recognizes it as an accelerator of the risk level. Imminence provides an ability to capture changing capabilities and intentions that are often viewed in cyber security relative to how they would impact the organization today, at this point in time. These risk vectors often result from changes in an organization's business model that impacts its employees and customers and the gradual emergence of technologies designed to penetrate existing deployed controls.

FIG. 20 is a table showing a targeting of groups of components relative to Likelihood according to some embodiments of the invention. In some embodiments, likelihood is rated from 1 to 3 using the average of the scores for targeting the group of components.

A final element of the organization's risk calculation is maturity. This is a measure of the effectiveness of the mitigation/controls for a given component or group of components. In some embodiments, it is scored as a weighted average of the effectiveness (%) for each type of control: preventive, detective, or corrective controls and the recoverability of the particular system component or group of component. In some embodiments, the initial weights are 30 for each of the recoverability and preventive scores and 20 for the corrective and detective scores. However, practitioners will appreciate that the specific weights presented herein are for description only and do not limit the scope of the invention.

To determine the maturity of a group of components, the lowest maturity effectiveness for the components may be the one used in the risk score calculation as this represents the highest risk. In some embodiments, the calculation for the development of the maturity value includes a control by control assessment (i.e., Yes/No) as to whether the applied control activities meet the control objectives. In the Risk Management Framework 100, these controls may have been originally developed through the Organizational Control Framework 500 and then tested or audited through any appropriate means. This linkage provides the ability to independently assess and report on an organization based on the maturity of a particular control or family of controls.

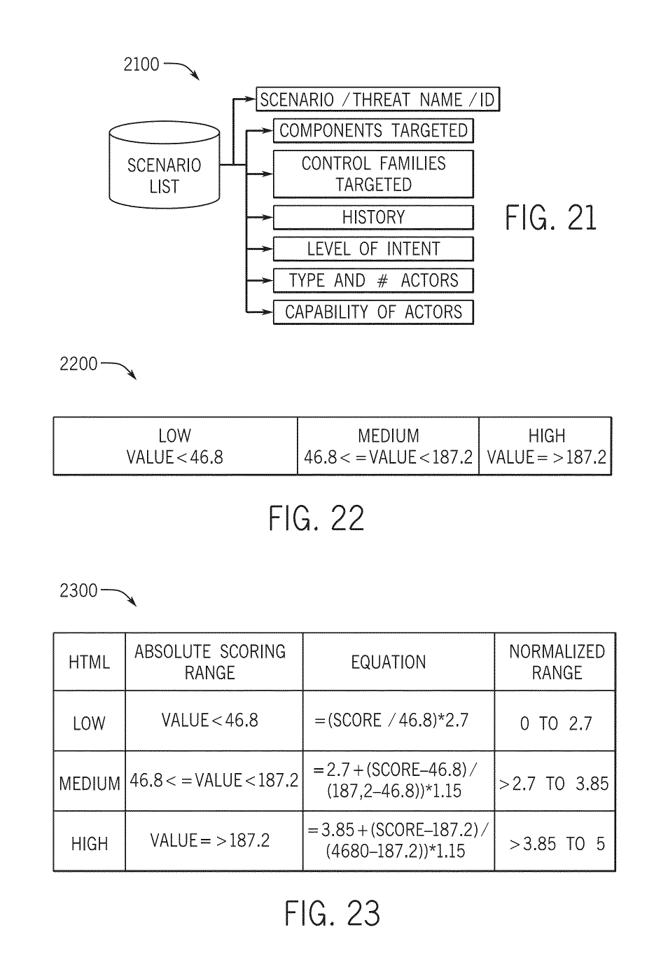

FIG. 21 is a diagram showing typical information used in scenario 110 development according to some embodiments of the invention. The core element of this method of risk calculation is the development of an appropriate scenario 110. Thus, in order for the Risk Framework to be effective, the list of scenario 110s may be updated frequently and maintained appropriately. Typical information for these scenario 110s that need to be maintained is shown in the diagram illustrated in FIG. 21.

### Risk Index Reporting

In some embodiments, the range of scores for the Risk Index 104 effectively ranges from 0 to 4680. As these numbers are not immediately intuitive in a risk management arena, it is typical to normalize these scores into tiers, High, Medium, and Low. In some embodiments, this may be accomplished using empirical methods with the calibration of the generated score against the organizationally accepted level of risk for that scenario 110. In lieu of this data, the following tiers are suggested as the starting point.
High to Medium Boundary: Worst possible risk frame mitigated with 100% mature controls for corrective and detective controls only without considering recoverability or prevention.
Medium to Low Boundary: Worst possible risk frame fully mitigated with 100% mature controls of all forms including recoverability.

FIG. 22 is a diagram showing a normalization of Risk Index 104 Scores into three tiers according to some embodiments of the invention. The separation of risk data into tiers results in the banding shown in FIG. 22. Using these parameters as an example, approximately 23% of all possible scores are High, 23% of all possible scores are Medium and the remainder would be Low.

FIG. 23 is a table outlining the use of information as a starting point in Risk Score range development according to some embodiments of the invention. To provide a means of reporting the Risk Index 104 in a range such as 1 to 5, the first step is to preserve the distribution of the HML bands that have been developed in the normalization process. The second step is to determine how to position the Risk Index 104 score into those bands. The table illustrated in FIG. 23 reflects the use of the information above as a starting point for this effort. A straight line approximation was used within each range.

In some embodiments, the development and evaluation of a full library of scenario 110s and the evolution of the scoring formats described above will require that this normalization scheme be revisited and evolved over time. As the scoring formats change it may be optimal to migrate previous risk scores into the new format, both as a control and also as to maintain the integrity of mitigation expenditures and effort based on the previous risk scores.

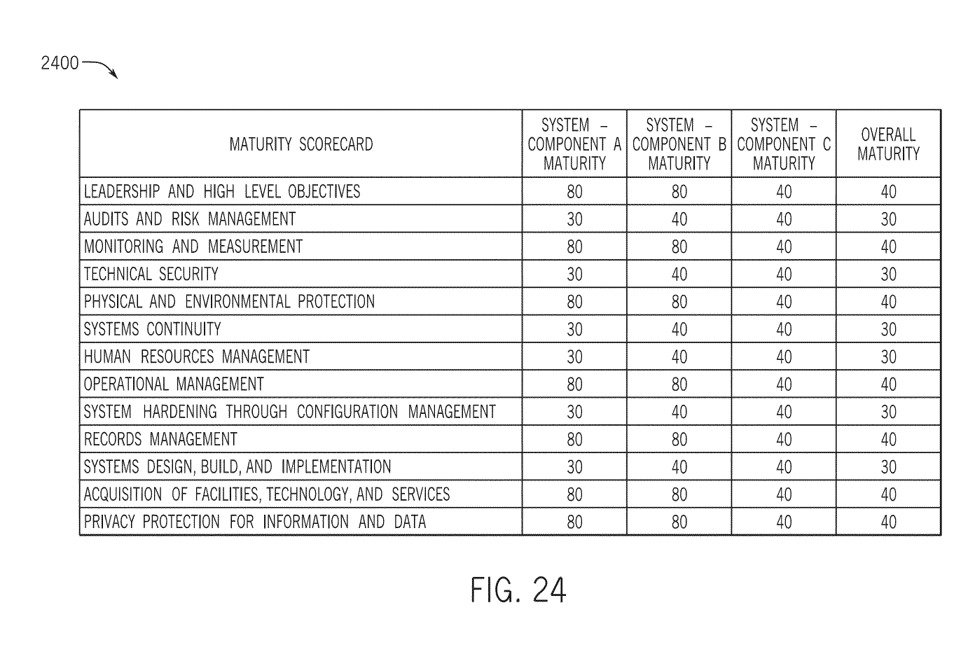

FIG. 24 is a table showing a maturity report reflecting an organization's ability and maturity to respond to any risk scenario 110 according to some embodiments of the invention. One result of the use of maturity as a separate factor in the determination of the Risk Index 104, is that it enables an organization to independently assess their ability and maturity to respond to any scenario 110. The heat map/table is provided as one potential form of reporting in this manner.

This data continues to require the development of a library of scenario 110s and their scoring. However, it does provide an effective manner for evaluating the capability of an organization's ability to respond to all threats. With this form of analysis assignment of organizational responsibility (accountability) and division of resources is easily accomplished.

### Operating the Risk Management Framework

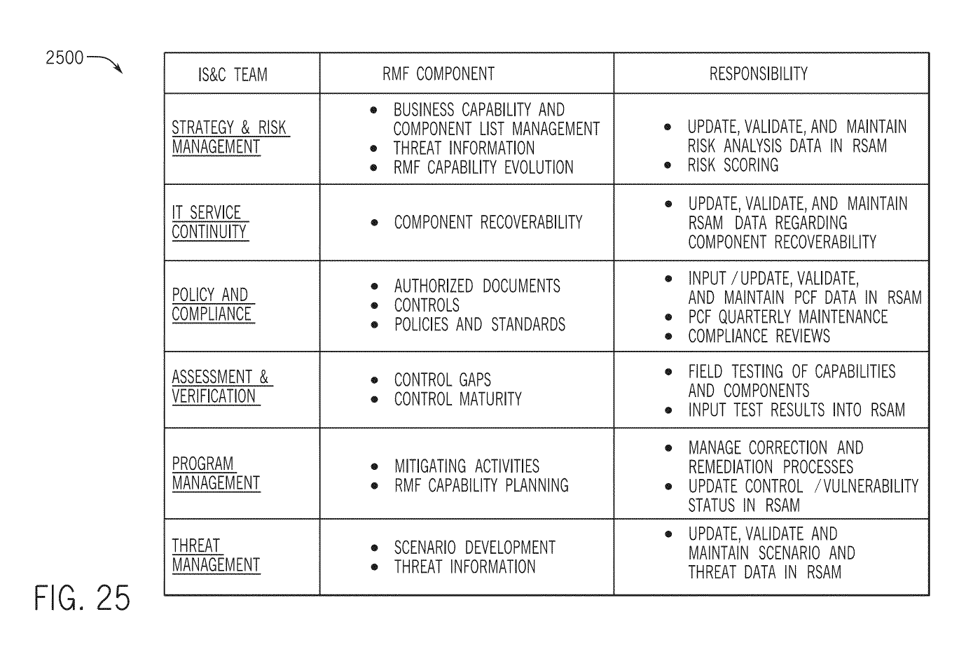

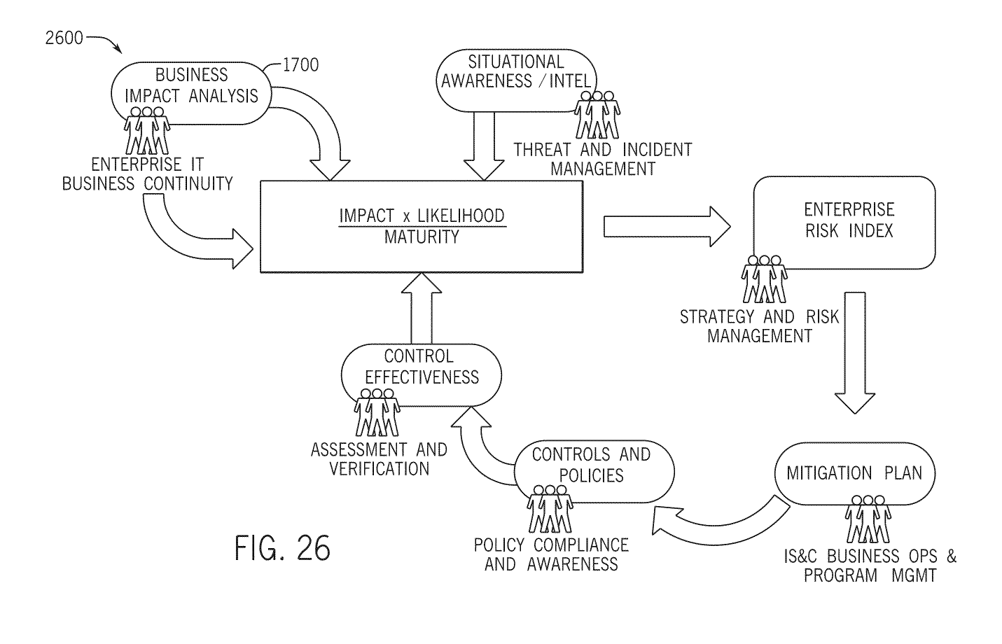

FIG. 25 is a table showing how various operations of the Risk Management Framework 100 can be broken out amongst various groups according to some embodiments of the invention. The Risk Management Framework 100 has been conceived to provide the information and security department at the organization with a comprehensive capability to rationalize their operations and provide a focus point to provide cohesion in their day-to-day activities.

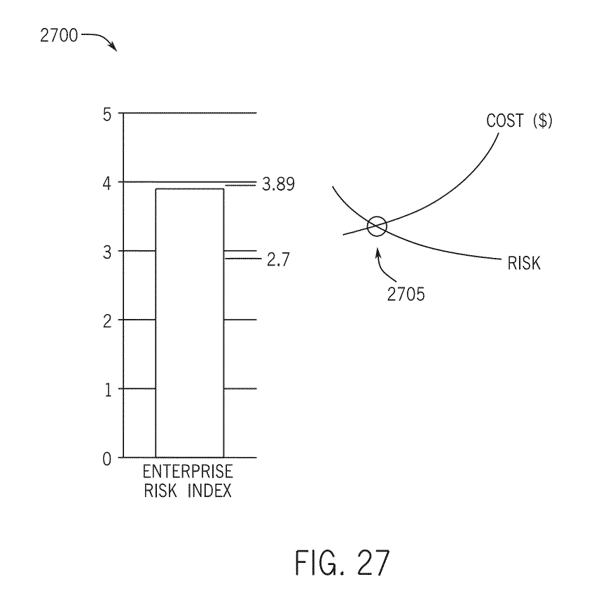

FIG. 27 is a chart showing the affects of continual investment in reducing risk according to some embodiments of the invention. As the disclosed Risk Framework matures, the expectation is that the organization will discover the right Risk Index (2700) measurement for operations. This becomes the Risk Index target (2705) for each new element or change to the production environment. The index target (2705) is the point where continual investment in reducing risk begins to increase while the net reduction in risk begins to decrease.

In some embodiments, the principle of a “high water mark” for risk may indicate that efforts to reduce risk for incoming components may not be beneficial due to the addition of such an element to the ‘pool’ not significantly altering the Enterprise Risk Index (2700).

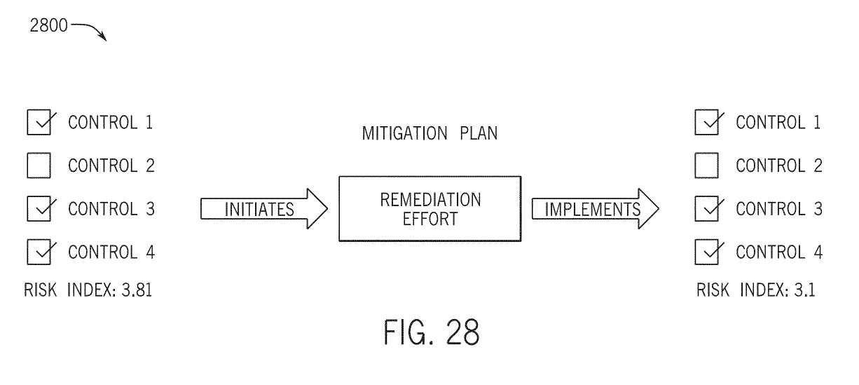

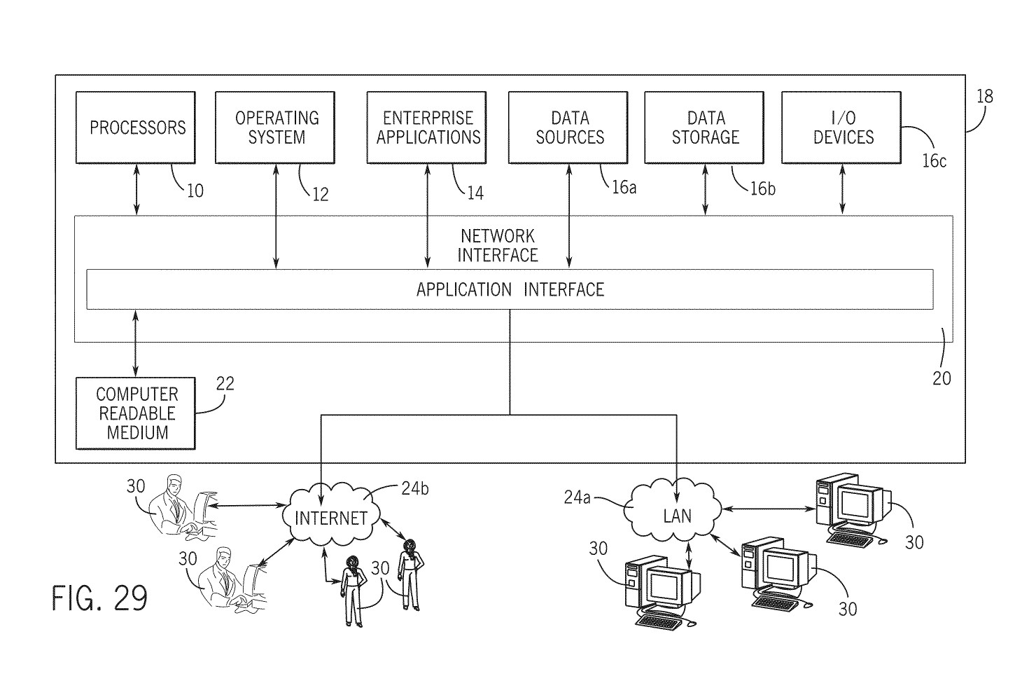

FIG. 28 is a chart showing a mitigation plan for changing a Risk Index 104 according to some embodiments of the invention. In some embodiments, when a control assessment (2800) is complete, gaps may exist that may need to be closed through a mitigation plan in order to bring the overall Risk Index 104 to the desirable level.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system as shown in FIG. 29 or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the invention.

1. A computer implemented method for managing risk, comprising:
determining an organizational impact score from an aggregate of scenario impact scores and storing the organizational impact score in a memory of the computer;
calculating a likelihood score based upon an analysis of threats, imminence of each threat, and a likelihood associated with each threat, and storing the likelihood score in a memory of the computer;
determining an organizational maturity score based on the ability of the organization to mitigate the actions of a potential threat and recover from a given scenario, and storing the organizational maturity score in a memory of the computer; and
calculating a Risk Index using a processor of the computer wherein the
Risk Index=(impact score)*(likelihood score)/(maturity score).

2. The method for managing risk of claim 1, wherein the Risk Index is normalized into tiers.

3. The method for managing risk of claim 2, wherein the tiers comprise low, medium and high.

4. The method for managing risk of claim 1, further comprising comparing investment in reducing risk to net reductions in risk provided by the investment.

5. The method for managing risk of claim 1, further comprising plotting investment in reducing risk to net reductions in risk provided by the investment to determine a Risk Index target.

6. The method for managing risk of claim 1, wherein the threats include at least a plurality of the group consisting of impact to vital records, personal information release, proprietary information, impact to DR capability, impact to staff retention and recruiting, damage to information integrity, stress/impact on consumer services, loss of income and opportunity, contract liability, cost of mitigation and penalties, increase in regulatory oversight, and third Party damage/harm and liabilities.

7. A non-transitory computer-readable medium having instructions executed by a processor of a computer, the instructions performing a method of managing risk comprising:
determining and using the processor to process an organizational impact score from an aggregate of scenario impact scores, the scenario impact scores being based on factors including potential loss of life, infrastructure harm, business operations harm and reputational harm;
storing the organizational impact score on the medium;
calculating a likelihood score based upon an analysis of threats, imminence of each threat, and a likelihood associated with each threat, and storing the likelihood score on the medium;
determining an organizational maturity score based on the ability of the organization to mitigate the actions of a potential threat and recover from a given scenario, and storing the organizational maturity score on the medium; and
calculating a Risk Index using the processor of the computer wherein the
Risk Index=(impact score)*(likelihood score)/(maturity score).

8. The method for managing risk of claim 6, wherein the Risk Index is normalized into tiers.

9. The method for managing risk of claim 7, wherein the tiers comprise low, medium and high.

10. The method for managing risk of claim 6, further comprising comparing investment in reducing risk to net reductions in risk provided by the investment.
